(19) United States
(12) Patent Application Publication
(10) Pub. No.: US 2005/0036322 A1
(43) Pub. Date: Feb. 17, 2005

(54) Lamp

(76) Inventor: Samuel C. Veffer, Toronto (CA)

Correspondence Address: SMART AND BIGGAR, 438 UNIVERSITY AVENUE, SUITE 1500 BOX 111, TORONTO, ON, M5G2K8, CA

(21) Appl. No.: 10/900,172

(22) Filed: Jul. 28, 2004

Related U.S. Application Data
(60) Provisional application No. 60/490,248, filed on Jul. 28, 2003.

(51) Int. Cl. F21V 33/00

(52) U.S. Cl. 362/373

(57) ABSTRACT

A lamp has a cover at least partially enveloping a light receptacle so as to define a receptacle chamber. A light trap is provided atop the cover with a first heat vent communicating between the receptacle chamber and an interior of said light trap and a second heat vent communicating between an interior of said light trap and an ambient environment. The light trap is arranged to at least substantially prevent light which enters the first heat vent from reaching the second heat vent while allowing heat which enters said first heat vent to pass through said second heat vent. With this arrangement, the light emitted from the cover may be blocked with a shroud without overheating the lamp.

### CROSS-REFERENCE TO RELATED APPLICATION

This application claims priority from U.S. provisional application No. 60/490,248, filed Jul. 28, 2003.

### BACKGROUND OF INVENTION

This invention relates to a lamp.

Sabbath observant Jews may not turn electrical switches on or off during the Sabbath: from sundown on Friday until after dark on Saturday. This can force a family to leave some lights on during this period, however, the illumination may disturb others, especially those trying to sleep.

This invention seeks to ameliorate this problem.

### SUMMARY OF INVENTION

The subject lamp reduces the inconvenience caused by a lamp that remains electrically turned on by providing a lamp suitable for reading or other purposes that is adapted to selectively provide light.

The lamp has a cover at least partially enveloping a light receptacle so as to define a receptacle chamber. A light trap is provided atop the cover with a first heat vent communicating between the receptacle chamber and an interior of said light trap and a second heat vent communicating between an interior of said light trap and an ambient environment. The light trap is arranged to at least substantially prevent light which enters the first heat vent from reaching the second heat vent while allowing heat which enters said first heat vent to pass through said second heat vent. With this arrangement, the light emitted from the cover may be blocked with a shroud without overheating the lamp.

Accordingly, the present invention provides a lamp comprising: a light receptacle; a cover at least partially enveloping said light receptacle so as to define a receptacle chamber; a light trap atop said cover; a first heat vent communicating between said receptacle chamber and an interior of said light trap; a second heat vent communicating between an interior of said light trap and an ambient environment; said light trap arranged to at least substantially prevent light which enters said first heat vent from reaching said second heat vent while allowing heat which enters said first heat vent to pass through said second heat vent.

Other features and advantages will become apparent from a review of the following description in conjunction with the drawings.

### BRIEF DESCRIPTION OF THE DRAWINGS

In the figures which illustrate example embodiments of the invention,

FIG. 1 is and exploded view of a lamp made in accordance with this invention,

FIG. 2 is a cross-sectional view of the lamp of FIG. 1,

FIG. 3 is a cross-sectional view along the lines 3-3 of FIG. 2,

FIG. 4 is a perspective view of a lamp made in accordance with another aspect of this invention, and

FIG. 5 is a cross-sectional view of the lamp of FIG. 4.

### DETAILED DESCRIPTION

Broadly, the lamp allows the escape of heat even when light from the lamp is blocked. In this regard, the lamp may have a moveable shade body providing a selectively sized aperture for allowing emission of a selective amount of light.

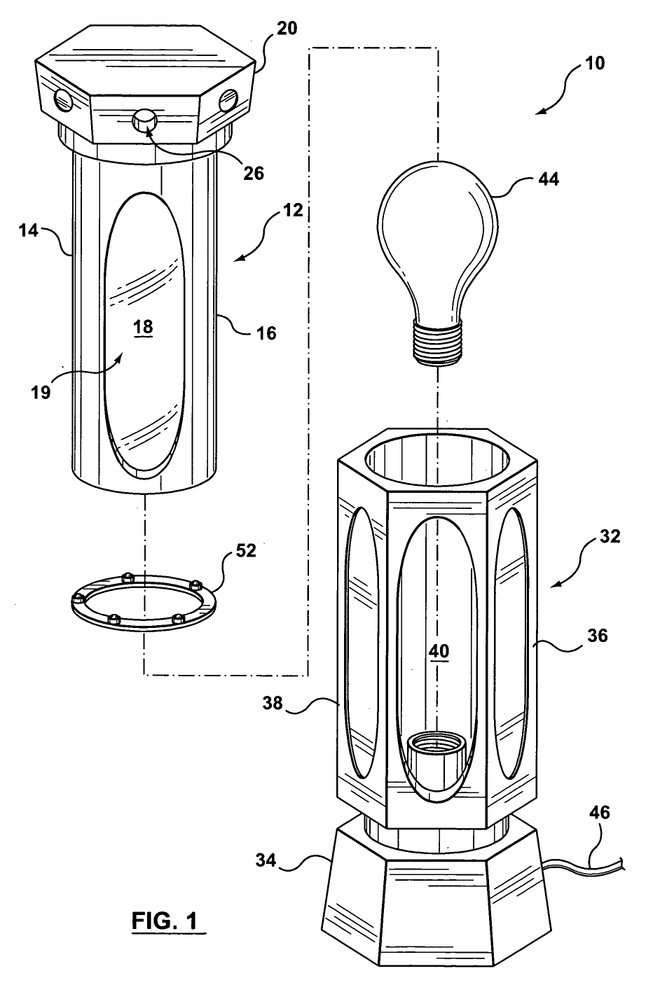

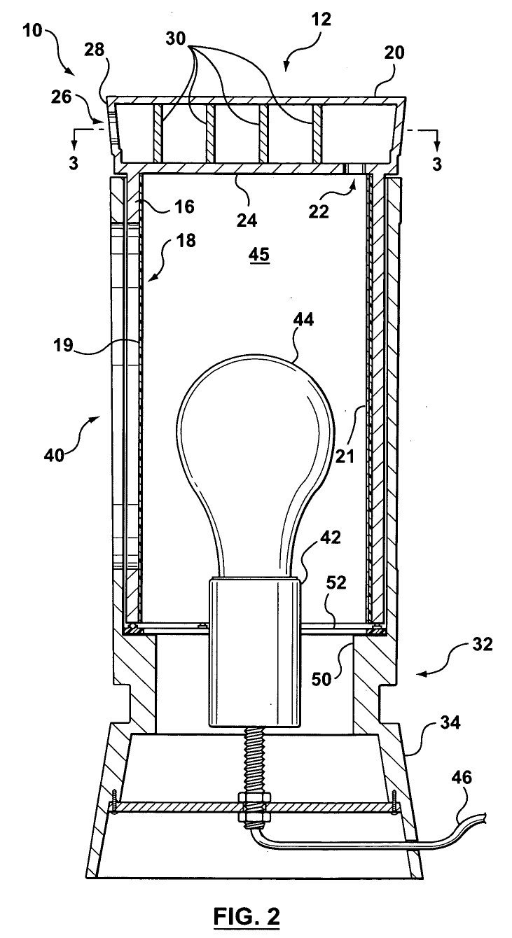

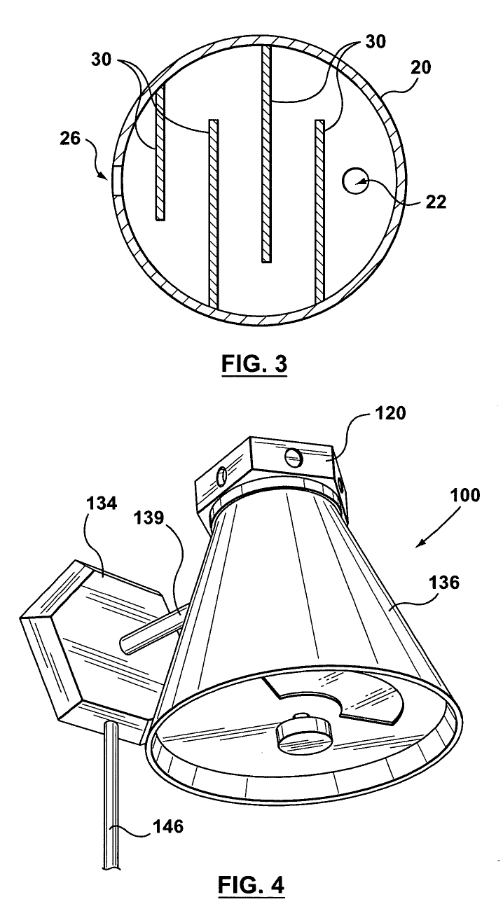

Turning to FIGS. 1 through 3, a table lamp 10 has a top unit 12 having a cylindrical tubular shroud 14 with a side wall 16 having an opening 18 therethrough. The opening is covered with a translucent light diffusing sheet 19. The lumen of the shroud is lined with a reflective sheet 21 opposite opening 18. A light trap 20 extends from the top end of the tubular shroud 14. As seen in FIGS. 2 and 3, there is an off-center heat vent hole 22 in the bottom wall 24 of the light trap inside of the cylindrical side wall 16 of tubular body 14. There is a second heat vent hole 26 in a side wall 28 of the light trap. A series of baffles 30 extend between the two heat vents so as to provide a tortuous path between the two heat vents.

A bottom unit 32 has a base 34 with a tubular cover 36 extending upwardly therefrom. The tubular cover 36 has a side wall 38 having an aperture 40 (the other like shaped areas of side wall 38 are not apertures). The base houses a light receptacle 42 extending inside of the cover 36 for a light 44. Thus, the cover defines a receptacle chamber 45. A cord 46 for the receptacle runs through the base 34. An annular support 50 extends from the base 34 within the cover 36. A bearing ring 52 rests on the annular support 50 and the base of the shroud 14 rests on the bearing ring 52. The shroud 14 and cover 36 are sized so that the clearance between the top of the cover and the bottom wall 24 of the light trap is small. Additionally, the clearance between the side wall 16 of the shroud and the side wall 38 of the cover 36 may be small. In consequence little, if any, light can escape through the top of the cover with the shroud resting on the ring bearing 52.

In operation, the light trap 20 may be grasped by a user and the top unit 12 rotated with respect to the bottom unit 36 so that the opening 18 in the shroud wall 16 may be partially or fully aligned with the aperture 40 in the cover 36. In this way, with the light 44 illuminated, a selective amount of light may be emitted from the lamp 10. Further, with the light illuminated, heat is vented through the vent holes 22, 26 in the light trap 20. However, little if any light can escape from the light trap because of the baffles 30 intervening between the vent holes.

Sabbath observant Jews are not permitted to move a light source. It will be apparent from the foregoing that when a user grasps the light trap 20 of lamp 10 and rotates the top unit 12, the bottom unit 36 does not move. Further, it is the bottom unit that supports the light receptacle 42. Consequently, the user does not move the light supporting bottom unit when rotating the top unit. Therefore, lamp 10 may be operated by Sabbath observant Jews.

The amount of light leaving the lamp is dependent upon the degree of overlap of the opening 18 in the shroud wall 16 and the aperture 40 in the side wall 38 of the cover 36. This degree of overlap is selected by a user rotating the top unit 12.

The shroud opening 18 may have a diffuser sheet 19 to diffuse light emitted by the lamp. The lamp may use high efficiency (low energy) bulbs. The reflective backdrop 21 increases the light emerging from the lamp when the cut-outs are aligned.

There are at least the following unique aspects of this lamp:
A non-electric dimming function: the amount of light emitted can be varied manually by rotating the shroud; the effect of a “dimmer” is accomplished with no special electronics nor special bulb.
A directional reading lamp: the shroud and cover, with their defined openings allow, for example, one person in a bedroom to read without the light disturbing another person sleeping in the room.
Sabbath use: the lamp can be effectively “turned off” without requiring electrically switching off the light and without moving the light source; this allows Sabbath observant Jews who may not turn electrical switches on or off to use the lamp as a bedside reading lamp on the Sabbath.

Thus, Sabbath use is only one of the uses of the subject lamp and lamp shade.

Optionally, more than one vent hole 22 and vent hole 26 may be provided so long as the baffles provide a tortuous path between all of the vent holes 22 in the bottom of the light trap and the vent holes 26 in the side of the light trap. Optionally, the base 34 may be enclosed and have an upper wall with at least one vent into the base separated from one or more holes in the side of the base by baffles. This would provide another egress for heat, while trapping light.

Rather than have the reflective backdrop lining the lumen of the shroud, it may be affixed to the inner surface of the base such that the light bulb is between the reflective backdrop and the aperture 40 in the side wall 38 of the cover 36.

Other arrangements may also be used to provide a table lamp which may allow a selective amount of light to emerge. For example, the shroud could comprise a box which may be opened a selective amount, which box may have a mirror as the backdrop such that the box also functions as a jewellery box. As a further alternative, the lamp could have a shroud with a sliding door or shutters. In all instances, a light trap may be provided above the light receptacle.

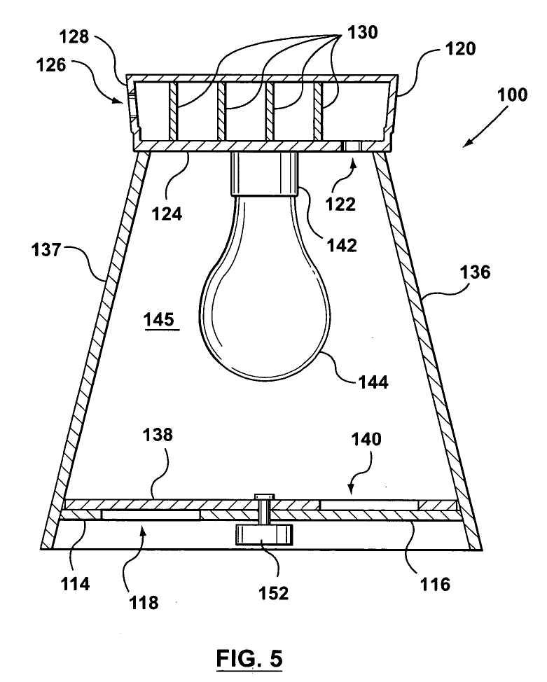

This invention may also be embodied in a wall lamp as, for example, the wall lamp 100 of FIGS. 4 and 5. Turning to these FIGS., wall lamp 100 has a cover 136 with a frusto-conical cover side wall 137 and a bottom wall 138 with an arcuate aperture 140 therein. The top wall 124 of the cover supports a light receptacle 142 for a light 144. Thus, the cover defines a receptacle chamber 145. A cord 146 for the receptacle runs through a tube 139 extending from the side wall 137 of the cover to a base 134. A light trap 120 extends from the top end of the cover 136. As seen in FIG. 5, there is an off-center heat vent hole 122 in the top wall 124 of the cover—which is also the bottom wall of the light trap—inside of the frusto-conical side wall 137 of cover 136. There is a second heat vent hole 126 in a side wall 128 of the light trap. A series of baffles 130 extend between the two heat vents so as to provide a tortuous path between the two heat vents.

The wall 116 of a disk-shaped shroud 114 has an arcuate opening 118 therethrough. The shroud 114 is centrally mounted to the bottom wall 138 of cover 136 by pivot 152 so that the shroud can be rotated with respect to the bottom wall 138 of cover 136.

In operation, the shroud may be rotated (by rotating the pivot 152) so that the opening 118 in the shroud is selectively aligned with aperture 140 in the bottom wall 138 of the cover 136. In this way, a selective amount of light may be emitted from lamp 100. Again, the light trap 120 acts to vent heat from the lamp, while trapping light.

Other modifications will be apparent to those skilled in the art and, therefore, the invention is defined in the claims.

1. A lamp comprising:
a light receptacle;
a cover at least partially enveloping said light receptacle so as to define a receptacle chamber;
a light trap atop said cover;
a first heat vent communicating between said receptacle chamber and an interior of said light trap;
a second heat vent communicating between an interior of said light trap and an ambient environment;
said light trap arranged to at least substantially prevent light which enters said first heat vent from reaching said second heat vent while allowing heat which enters said first heat vent to pass through said second heat vent.

2. The lamp of claim 1 wherein said light trap provides a tortuous path between said first heat vent and said second heat vent.

3. The lamp of claim 2 wherein said light trap comprises a series of baffles.

4. The lamp of claim 1 wherein said cover is fixed to said receptacle.

5. The lamp of claim 4 wherein said cover has an aperture.

6. The lamp of claim 5 further comprising a shroud rotatable with respect to said cover for selectively unblocking, partially blocking, or completely blocking said aperture.

7. The lamp of claim 6 wherein said shroud has a wall and an opening in its wall rotatable into alignment with said aperture of said cover.

8. The lamp of claim 7 wherein one of said shroud opening and said cover aperture is covered with a light diffusing sheet.

9. The lamp of claim 7 wherein said cover is tubular and said aperture is an opening in a wall of said cover.

10. The lamp of claim 9 further comprising an annular support within said cover below said aperture and wherein said shroud is tubular and rests on said support.

11. The lamp of claim 10 further comprising a bearing ring on said annular support against which said shroud rests.

12. The lamp of claim 10 wherein said annular support is in said receptacle chamber.

13. The lamp of claim 12 wherein a lumen of said tubular shroud is at least partially lined with a light reflective sheet.

14. The lamp of claim 10 wherein said shroud terminates in said light trap.

15. The lamp of claim 7 wherein said aperture is a downwardly opening aperture.

16. The lamp of claim 15 wherein said cover comprises a disk, said disk having said aperture.

17. The lamp of claim 16 wherein said shroud comprises a disk, said disk having said opening, said shroud disk rotatably mounted to said cover disk.

18. The lamp of claim 17 wherein said light trap is affixed to a top of said cover.
